(19) United States
(12) Patent Application Publication
(10) Pub. No.: US 2025/0270138 A1
(43) Pub. Date: Aug. 28, 2025

(54) LIGHTWEIGHT CEMENT COMPOSITION AND METHOD OF MAKING CURED LIGHTWEIGHT CEMENT THEREFROM

(71) Applicant: KING FAHD UNIVERSITY OF PETROLEUM AND MINERALS, Dhahran (SA)

(72) Inventors: Khaled Own MOHAISEN, Dhahran (SA); Md. Hasan ZAHIR, Dhahran (SA); Mohammed MASLEHUDDIN, Dhahran (SA)

(73) Assignee: KING FAHD UNIVERSITY OF PETROLEUM AND MINERALS, Dhahran (SA)

(21) Appl. No.: 18/584,560

(22) Filed: Feb. 22, 2024

(51) Int. Cl. C04B 20/10; C04B 14/16; C04B 16/04; C04B 28/04; C04B 40/00; C04B 103/00; C04B 111/40

(52) U.S. Cl. CPC C04B 20/1037; C04B 14/16; C04B 16/04; C04B 20/1077; C04B 28/04; C04B 40/0032; C04B 2103/0071; C04B 2111/40; C04B 2201/32; C04B 2201/50

(57) ABSTRACT

A lightweight cement composition contains a curable component in an amount of 15 to 25 wt. %, a fine aggregate (FA) in an amount of 40 to 45 wt. %, a coarse aggregate (CA) in an amount of 3 to 30 wt. %, each wt. % based on a total weight of the lightweight cement composition. The CA contains a form-stabilized phase change material (FS-PCM) composite having a core of scoria-polyethylene glycol (SCP) composite and a cement shell. A cured lightweight cement specimen, and a method of making the cured lightweight cement specimen.

### BACKGROUND

### Technical Field

The present disclosure is directed to the field of building materials, particularly to a lightweight cement composition and a cured specimen made therefrom, and a method of making a cured lightweight cement specimen therefrom, for enhanced thermal energy storage and improved structural integrity.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Concrete stands as a foundational material in the construction industry, valued for its robustness, durability, and ease of production. Traditional concrete is composed of aggregates, cement, and water, and is widely employed in diverse construction applications. However, traditional concrete does not possess thermal energy storage capabilities, thus preventing it from actively contributing to energy efficiency in buildings. This limitation becomes increasingly critical in the context of global trends towards sustainable construction practices and energy conservation in modern energy-efficient building designs. The absence of thermal energy storage (TES) capabilities in traditional concrete necessitates heavy reliance on mechanical heating and cooling systems within buildings. This reliance contributes significantly to energy consumption and greenhouse gas emissions, raising pressing environmental concerns. Addressing this shortfall is paramount as we strive towards more sustainable construction methods and environmentally-conscious building solutions.

Conventional approaches to address this issue typically involve altering the composition of concrete to integrate materials that can store and release thermal energy. Such materials, known as phase change materials (PCMs), are incorporated into concrete to improve its thermal regulation properties. These materials may absorb, store, and release thermal energy, thereby enhancing the thermal regulation properties of concrete. However, the integration of PCMs into concrete is not devoid of challenges. It often involves intricate processes or the use of materials that may not be environmentally-sustainable or cost-effective over the long-term. For instance, the leakage of PCMs can affect the properties of concrete. Moreover, concerns arise regarding the environmental impact of certain PCMs and the complexity associated with integrating them into traditional concrete production methods.

CN108546034A discloses a cement composition containing a polymer powder, and an aggregate. Additionally, the polymer powder includes polyethylene glycol. However, CN108546034A does not describe: (i) a shape-stabilized phase change material (FS-PCM) composite having a core-shell structure, and (ii) the scoria polyethylene glycol (SCP) composite core having an average particle size of preferably, e.g., about 0.5 to 2 cm in the longest dimension.

CN103193432A discloses a cement composition containing an aggregate, and a phase change material, e.g., polyethylene glycol. Additionally, the polyethylene glycol may be adsorbed into the inner holes of the aggregate. However, CN103193432A does not describe (i) a FS-PCM composite having a core-shell structure, and (ii) the SCP composite core having an average particle size of preferably, e.g., about 0.5 to 2 cm in the longest dimension.

U.S. Pat. No. 6,907,708B2 discloses a cement composition containing a coarse aggregate including scoria, and polyethylene glycol as a viscosity modifier. Also, U.S. Pat. No. 6,907,708B2 does not describe (i) a FS-PCM composite having a core-shell structure, and (ii) the SCP composite core having an average particle size of preferably, e.g., about 0.5 to 2 cm in the longest dimension.

U.S. Pat. No. 10,472,485B2 discloses a scoria composite impregnated with poly(ethylene oxide). The scoria particles have an average particle size of 0.1 to 2 μm. However, U.S. Pat. No. 10,472,485B2 does not describe (i) a cement composition containing a FS-PCM composite, (ii) the FS-PCM composite having a core-shell structure, and (iii) the SCP composite core having an average particle size of preferably, e.g., about 0.5 to 2 cm in the longest dimension.

Jafarabad et al. (Can. J. Civ. Eng., 2019) discloses a cement composition containing a cement, a polyethylene glycol phase change material, and a scoria aggregate. The polyethylene glycol may be adsorbed into the inner holes of the scoria aggregate prior to mixing with the cement. However, Jafarabad does not describe (i) a FS-PCM composite having a core-shell structure, (ii) the SCP composite core having an average particle size of preferably, e.g., about 0.5 to 2 cm in the longest dimension, and (iii) the SCP composite core is capsulated within a cement shell.

Mokhtari et al. (Case Stud. Constr. Mater., 2022) discloses a shape-stabilized phase change material (FS-PCM) composite containing silica fume impregnated with polyethylene glycol. The FS-PCM composite may be prepared by a vacuum impregnation method. However, Mokhtari et al. do not describe (i) a cement composition containing the FS-PCM composite, (ii) the FS-PCM composite having a core-shell structure, and (iii) the SCP composite core having an average particle size of preferably, e.g., of about 0.5 to 2 cm in the longest dimension.

Marani et al. (J. Mater. Res. Technol., 2021) disclose a cement composition containing an aggregate and polyethylene glycol. However, Marani et al. do not describe (i) a FS-PCM composite having a core-shell structure, (ii) the SCP composite core having an average particle size of preferably, e.g., about 0.5 to 2 cm in the longest dimension, and (iii) the SCP composite core is encapsulated within a cement shell.

Li et al. (Chem. Eng. Technol., 2010) discloses a cement composition containing an aggregate and polyethylene glycol. However, Li does not describe (i) a FS-PCM composite having a core-shell structure, (ii) the SCP composite core having an average particle size of preferably, e.g., about 0.5 to 2 cm in the longest dimension, and (iii) the SCP composite core is encapsulated within a cement shell.

The drawbacks of each of the compositions and methods described above indicate that there is still a need for producing a concrete material with enhanced thermal energy storage property, improved environmental-sustainability, and increased structural-integrity. More importantly, the challenge is that such compositions and methods should be cost-effective and rapid to attract industries to adopt these processes.

In view of the foregoing, it is one objective of the present disclosure to provide a lightweight cement composition. A second objective of the present disclosure is to provide a cured specimen made from the lightweight cement composition. A third objective of the present disclosure is to provide a method of making the cured lightweight cement specimen including a step of preparing the SCP composite.

### SUMMARY

In an exemplary embodiment, a lightweight cement composition is provided. The lightweight cement composition contains a curable component in an amount of 15 to 25 wt. % based on a total weight of the lightweight cement composition. The lightweight cement composition further contains a fine aggregate (FA) in an amount of 40 to 45 wt. % based on the total weight of the lightweight cement composition. The lightweight cement composition further contains a coarse aggregate (CA) in an amount of 3 to 30 wt. % based on the total weight of the lightweight cement composition. In some embodiments, the CA contains a form-stabilized phase change material (FS-PCM) composite comprising a core of scoria polyethylene glycol (SCP) composite and a cement shell.

In some embodiments, the SCP composite has a specific gravity of about 1.8. In some embodiments, the SCP composite has a water absorption of about 5.5% based on a total weight of the SCP composite, as determined by ASTM C127.

In some embodiments, the SCP composite comprises SCP particles having a polyhedron shape and an average particle size of 0.5 to 2 centimeters (cm) in the longest dimension.

In some embodiments, the cement shell of the FS-PCM composite has an average thickness of 0.1 to 1 millimeters (mm).

In some embodiments, the cement shell is made of Type I ordinary portland cement (OPC), and wherein the OPC meets the chemical and physical requirements of ASTM C150.

In some embodiments, the SCP composite comprises 25-35 wt. % of polyethylene glycol (PEG) based on a total weight of the SCP composite; and 65-75 wt. % of scoria based on the total weight of the SCP composite. In some embodiments, the PEG at least partially penetrates voids in the porous scoria.

In some embodiments, the PEG has an average molecular weight of about 2000 to 10,000 g/mol.

In some embodiments, the scoria has a specific gravity of about 1.5. In some embodiments, the scoria has a water absorption of about 11% based on a total weight of the scoria, as determined using the procedures outlined in ASTM C127.

In some embodiments, the scoria has a thermal conductivity of about 0.27 W/mK.

In some embodiments, the curable component includes at least one selected from the group consisting of portland cement, pozzolan cement, gypsum cement, aluminous cement, silica cement, and alkaline cement.

In some embodiments, the FA has a specific gravity of about 2.56. In some embodiments, the FA has a water absorption of about 0.6% based on a total weight of the FA, as determined by ASTM C128.

In another exemplary embodiment, a cured specimen made from the aforementioned lightweight cement composition is provided. In some embodiments, the cured specimen has a compressive strength of 3 to 30 MPa.

In yet another exemplary embodiment, a cured specimen made from the aforementioned lightweight cement composition is provided. In some embodiments, the cured specimen has a thermal conductivity of 1 to 1.6 watts per meter-kelvin (W/mK).

In still another exemplary embodiment, a cured specimen made from the aforementioned lightweight cement composition is provided. In some embodiments, the cured specimen has a thermal resistivity of 0.8 to 1.5 m²K/W.

In still another exemplary embodiment, a method of making a cured lightweight cement specimen is provided. The method includes mixing the aforementioned lightweight cement composition with water to form a mortar composition. The method further includes casting the mortar composition in a mold to form a molded composition. The method further includes curing the molded composition for 0.5-30 days thereby forming the cured lightweight cement specimen.

In some embodiments, the water is at least one selected from the group consisting of tap water, ground water, distilled water, deionized water, fresh water, and desalted water.

In some embodiments, a weight ratio of water to the curable component present in the lightweight cement composition is in a range of 0.4:1 to 0.6:1.

In some embodiments, the method further includes preparing the SCP composite by placing particles of scoria in a chamber under a vacuum for an appropriate amount of time; introducing PEG into the chamber in contact with the particles of scoria and heating in the vacuum environment to form a crude scoria composite; and removing an excessive amount of PEG from the crude scoria composite by drying to form the SCP composite.

In some embodiments, the heating is performed at a temperature of 50 to 90° C. under a pressure of about 0.05 to 0.2 MPa.

In some embodiments, the method further comprises constructing a building by aligning a plurality of cured lightweight cement specimens in side by side alignment to form a structural element of the building.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a pictorial depiction of scoria-polyethylene glycol (SCP) particles of the SCP composite present in the lightweight cement composition, according to certain embodiments;

FIG. 2A is a pictorial depiction of a coarse aggregate (CA) or a form-stabilized phase change material (FS-PCM) composite therein for the lightweight cement composition, according to certain embodiments;

FIG. 2B is a pictorial depiction of the FS-PCM composite split in two parts across a section A of FIG. 2A, according to certain embodiments;

FIG. 2C is a scanning electron micrograph (SEM) of the FS-PCM composite, according to certain embodiments;

FIG. 2D is an Energy-Dispersive X-ray Spectroscopy (EDS) spectra for a first region in the SEM of the FS-PCM composite of FIG. 2C, according to certain embodiments;

FIG. 2E is an EDS spectra for a second region in the SEM of the FS-PCM composite of FIG. 2C, according to certain embodiments;

FIG. 3 is an exemplary flowchart of a method of making a cured lightweight cement specimen, according to certain embodiments;

FIG. 4 is a schematic of an exemplary set-up for preparing the SCP composite, according to certain embodiments;

FIG. 5 is a graph showing the output from differential scanning calorimetry (DSC) before and after 200 thermal cycles of the SCP composite, according to certain embodiments;

FIG. 6 is a graph showing thermal conductivity and thermal resistivity values of Modified Scoria Concrete (MSC) and SCP concrete specimens, according to certain embodiments;

FIG. 7A is a graph showing the temperature profile of heating and cooling temperature cycles at the bottom of the concrete panels, according to certain embodiments;

FIG. 7B is a graph showing a first enlarged view of heating and cooling profiles of the graph of FIG. 7A, according to certain embodiments; and

FIG. 7C is a graph showing a second enlarged view of the heating and cooling profiles of the graph of FIG. 7A, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, like reference numerals designate identical or corresponding parts throughout the several views. Further, as used herein, the words “a,” “an” and the like generally carry a meaning of “one or more,” unless stated otherwise.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

The use of the terms “include,” “includes”, “including,” “have,” “has,” or “having” should be generally understood as open-ended and non-limiting unless specifically stated otherwise.

As used herein, the term “cement” generally refers to a composition or substance with one or more constituents that is capable of binding materials together. The term includes reference to a dry, pre-set composition unless the context clearly dictates otherwise.

The phrase “cementitious material”, “cementitious binder material” or “binder” generally refers to materials or mixtures of materials that are capable of binding the aggregates in concrete.

As used herein, the term “aggregate” generally refers to a broad category of particulate material used in construction. Aggregates are a component of composite materials, such as concrete; the aggregates serve as reinforcement to add strength to the overall composite material. Aggregates, from different sources, or produced by different methods, may differ considerably in particle shape, size, and texture. The shape of the aggregates of the present disclosure may be cubical and reasonably regular, essentially rounded, angular, or irregular. Surface texture may range from relatively smooth with small exposed pores to irregular with small to large exposed pores. Particle shape and surface texture of both fine and coarse aggregates may influence proportioning of mixtures and other factors, such as workability, pumpability, fine-to-coarse aggregate ratio, and water requirement.

Aspects of this disclosure are directed to a cement composition, and a cured specimen made therefrom to enhance the efficiency and functionality of building materials. The cement composition of the present disclosure improves thermal energy management within construction applications, addressing the limitations of traditional concrete. Moreover, the cement composition of the present disclosure shows improved durability, environmental-sustainability, and energy efficiency, representing an advancement in modern construction practices.

In particular, the present disclosure provides a lightweight cement composition for the field of construction. The lightweight cement composition of the present disclosure in a cured form may serve as a construction material with enhanced thermal efficiency and structural integrity.

In the context of the present disclosure, “wt. %” stands for weight percent, and is used as a way of expressing the concentration of a component in a mixture as a percentage of the total weight of the mixture. For example, if a component is said to be present at 10 wt. % in the lightweight cement composition, it means that the component makes up 10% of the total weight of the lightweight cement composition.

Aspects of the present disclosure are directed to a lightweight cement composition. The lightweight cement composition contains a curable component in an amount of 5 to 35 wt. %, preferably 10 to 30 wt. %, preferably 15 to 25 wt. %, or even more preferably about 20 wt. %, based on a total weight of the lightweight cement composition. Other ranges are also possible. The curable component may define the physical and mechanical properties of resulting concrete (like a cured specimen, as discussed later in the description). The proportion of the curable component within the mixture of lightweight cement composition is calibrated to ensure optimal performance in terms of strength, durability, and workability. This proportion helps in achieving the desired characteristics in the resulting concrete, such as adequate compressive strength and suitable setting time, making it suitable for a wide array of construction applications. Further, the interaction(s) of the curable component with other constituents of the composition, particularly in terms of chemical reactions during the curing process, may influence the thermal and structural performance of the resulting concrete, aligning with the objectives of energy conservation and sustainability in modern building practices of the present disclosure.

In an embodiment, the curable component comprises at least one cementitious material selected from the group consisting of ordinary portland cement (OPC), pozzolan cement, gypsum cement, aluminous cement, silica cement, and alkaline cement. This diverse range ensures versatility in application and performance. Each type of cement brings unique properties to the composition. For instance, portland cement is known for its strength and durability, pozzolan cement for its environmental benefits, gypsum cement for its rapid setting, aluminous cement for high temperature resistance, silica cement for enhancing strength, and alkaline cement for chemical resistance. The choice of cement type can be tailored to specific construction needs, allowing for customization in terms of structural and thermal properties of the final concrete product. This flexibility in the composition enhances the overall functionality of the lightweight cement composition.

In some embodiments, the cementitious material present in the curable component is OPC. The OPC is selected from the group consisting of Type I, Type II, Type III, Type, IV, Type V, Type Ia, IIa, IIIa, or a combination of any two or more types of OPC. In a specific embodiment, the cementitious material is the Type I ordinary Portland cement (OPC), and the OPC has a standard specification of ASTM C150 (Standard Specification for Portland Cement, ASTM C150, which is incorporated herein by reference in its entirety).

As used herein, the term “ordinary portland cement,” or “portland cement” generally refers to the most common type of cement in general use developed from types of hydraulic lime and usually originating from limestone and clay. It is a fine powder produced by heating materials in a kiln to form what is called clinker, grinding the clinker, and adding small amounts of other materials to achieve the required properties. The Portland cement is made by heating limestone (calcium carbonate) with other materials (such as clay) to >1400° C. This process in a kiln is also known as calcination, whereby carbon dioxide is liberated from the calcium carbonate to form calcium oxide, or quicklime, which is then blended with the other materials that have been included in the mix to from calcium silicate. The resulting hard substance, called “clinker” is then ground with a small amount of gypsum into a powder to make ordinary Portland cement (OPC). Several types of Portland cement are available with the most common being called ordinary Portland cement (OPC) which is grey in color.

Suitable examples of cementitious materials include hydraulic cements, Saudi Class G hydraulic cement, non-hydraulic cements, Portland fly ash cement, Portland Pozzolan cement, Portland silica fume cement, masonry cement, energetically modified cement (EMC), stuccos, plastic cement, expansive cement, white blended cement, Pozzolan-lime cement, slag-lime cement, supersulfated cement, calcium aluminate cement, calcium sulfoaluminate cement, geopolymer cement, Rosendale cement, polymer cement mortar, lime mortar, and/or pozzolana mortar. In some embodiments, silica (SiO₂) may be present in the cement. In one embodiment, the cement comprises a cement blend of two or more types of cement, for example, a blend comprising Portland cement and non-Portland hydraulic cement. In a further embodiment, the cement is in the dry form. The cement may include SiO₂-containing materials including, but not limited to, belite (2CaO·SiO₂), alite (3CaO·SiO₂), celite (3CaO·Al₂O₃), or brownmillerite (4CaO·Al₂O₃·Fe₂O₃).

The lightweight cement composition further comprises a fine aggregate (FA) in an amount of 30 to 60 wt. %, preferably 35 to 55 wt. %, preferably 40 to 50 wt. %, or even more preferably 40 to 45 wt. % based on the total weight of the lightweight cement composition. Other ranges are also possible. The FA is integral to the overall structural and functional characteristics of the lightweight cement composition. The FA may have a role in filling voids and contributing to overall cohesion and stability of concrete The FA also plays a role in determining the workability and surface finish of the resulting concrete, for achieving the desired physical and aesthetic properties. This significant proportion of FA, in the amount of 40 to 45 wt. %, ensures that the lightweight cement composition has the right balance of strength and density, contributing to its lightweight nature. This percentage range for the FA is selected to optimize these characteristics, enhancing the suitability of the lightweight cement composition for a variety of construction applications, especially where weight considerations are paramount.

In some embodiment, the FA has a specific gravity of 2 to 3, preferably 2.2 to 2.8, preferably 2.4 to 2.6, or even more preferably about 2.56 as determined by ASTM C128 (Standard Test Method for Relative Density (Specific Gravity) and Absorption of Fine Aggregate, ASTM C128, which is incorporated herein by reference in its entirety). Other ranges are also possible. In some embodiments, the FA has a water absorption of 0.1 to 5%, preferably 0.2 to 4%, preferably 0.3 to 3%, preferably 0.4 to 2%, preferably 0.5 to 1%, or even more preferably about 0.6% based on a total weight of the FA, as determined by ASTM C128. Other ranges are also possible. As used herein, the ‘ASTM C128’ is a standard test method developed by the American Society for Testing and Materials (ASTM) that outlines the procedure for determining the density, relative density (specific gravity), and absorption of fine aggregates. The FA specified in the lightweight cement composition, with the specific gravity of about 2.56 and the water absorption of approximately 0.6% as per ASTM C128, ensures the optimal balance of strength and weight in the resulting concrete. The low water absorption and specific gravity indicate a reasonably dense material, contributing to the overall mass and structural integrity of the resulting concrete. These properties of the FA help in maintaining the desired consistency, workability, and durability of the lightweight cement composition, making it suitable for a range of construction applications that require lightweight yet strong materials.

In some embodiments, the fine aggregate may include, but is not limited to, sand (e.g., dune sand), crushed stone, crushed rock, crushed shells, or other crushed/pulverized/ground material, for example, crushed/pulverized/ground forms of concrete, gravel, rocks, natural soil, quarried crushed mineral aggregates from igneous (granite, syenite, diorite, gabbro peridotite pegmatite, volcanic glass, felsite, basalt), metamorphic (marble, metaquartzite, slate, phyllite, schist, amphibolite, hornfels, gneiss, serpentite) or sedimentary rocks (conglomerate, sandstone, claystone, siltstone, argillite, shale, limestone, dolomite, marl, chalk, chert), including unused and waste aggregates from quarry operations, dredged aggregates, china clay stent, china clay wastes, natural stone, recycled bituminous pavements, recycled concrete pavements, reclaimed road base and subbase materials, crushed bricks, construction and demolition wastes, crushed glass, slate waste, waste plastics, egg shells, sea shells, barite, limonite, magnetite, ilmenite, hematite, iron, steel, including recycled or scrap steel, and mixtures thereof. In some preferred embodiments, the fine aggregate employed in the lightweight cement composition is sand.

In a preferred embodiment, the fine aggregate is sand. As used herein, “sand” refers to a naturally occurring granular material composed of finely divided rock and mineral particles. It is defined by size in being finer than gravel and coarser than silt. The composition of sand varies, depending on the local rock sources and conditions, but the most common constituent of sand is silica (silicon dioxide, or SiO₂), usually in the form of quartz. In terms of particle size, sand particles range in diameter from 0.0625 mm to 2 mm. An individual particle in this range is termed a sand grain. By definition sand grains are between gravel (particles ranging from 2 mm to 64 mm) and silt (particles ranging from 0.004 mm to 0.0625 mm). In a specific embodiment, the fine aggregate has a specific gravity of preferably 2.2, preferably 2.3, preferably 2.4, and preferably 2.5, preferably 2.56. Other ranges are also possible.

The fine aggregate may have an average particle size of 0.3 to 1 mm, preferably 0.4 to 0.8 mm, preferably 0.5 to 0.6 mm, although fine aggregates with average particle sizes slightly above or below these values may also function as intended. The grading of fine aggregate employed herein preferably conforms to the standard ASTM C 33/C33M-18.

The lightweight cement concrete composition further comprises a coarse aggregate (CA) in an amount of 1 to 40 wt. %, preferably 2 to 35 wt. %, preferably 3 to 30 wt. %, preferably 4 to 25 wt. %, or even more preferably 5 to 20 wt. % based on the total weight of the lightweight cement concrete composition. Other ranges are also possible. In the lightweight cement concrete composition, the CA provides bulk volume, reduces shrinkage, and enhances the strength of the resulting concrete. The larger particle size of the CA compared to the FA contributes to the overall texture and structural framework of the resulting concrete. The versatility provided by this percentage range of the CA enables the lightweight cement composition to be tailored for various construction needs, enhancing its practicality in diverse building scenarios. In particular, this percentage range for the CA is selected to optimize the density and durability of the lightweight cement composition while maintaining its lightweight characteristic, especially for diverse construction applications where weight is a critical factor.

In the present disclosure, the CA comprises a form-stabilized phase change material (FS-PCM) composite comprising a core of scoria impregnated with polyethylene glycol (SCP) and covered by a cement shell. In some embodiments, the FS-PCM composite in the lightweight cement composition plays a role in enhancing its thermal energy storage capacity. The FS-PCM composite, incorporating the phase change material, allows the lightweight cement composition to absorb, store, and subsequently release thermal energy. This characteristic may improve the energy efficiency of structures built with the lightweight cement composition of the present disclosure, making it highly beneficial in climates with significant temperature variations. The SCP composite, a core component of the FS-PCM, includes the scoria which is a lightweight, porous volcanic rock for absorbing polyethylene glycol, known for its phase change properties. The SCP composite, thereby, enables the lightweight cement composition to regulate temperature through thermal energy storage, contributing significantly to the energy efficiency of buildings. The cement shell in the FS-PCM composite encapsulates the SCP composite, ensuring structural integrity and preventing leakage of the phase change material therefrom. The presence of the cement shell ensures that the thermal properties of the FS-PCM composite are utilized within matrix of the resulting concrete formed using the lightweight cement composition. This combination of the SCP composite and the cement shell within the FS-PCM composite of the CA contributes to the overall functional and environmental benefits of the lightweight cement composition. In the lightweight cement composition, the CA provides the thermal energy storage capabilities to the resulting concrete. This capacity for thermal energy management is integral to enhancing the energy efficiency of buildings.

In an embodiment, the SCP composite comprises SCP particles having a polyhedron shape. In another embodiment, the SCP composite comprises SCP particles may have a geometric shape selected from the group consisting of a sphere, an Archimedes shape, a Plato shape, a polyhedron, a prism, an anti-prism, and combinations thereof. In some embodiments, the SCP composite comprises SCP particles having an average particle size of 0.1 to 5 centimeters (cm), preferably 0.2 to 4 cm, preferably 0.3 to 3 cm, preferably 0.4 to 2.5 cm, preferably 0.5 to 2, or even more preferably 0.6 to 1.5 cm in the longest dimension. Other ranges are also possible.

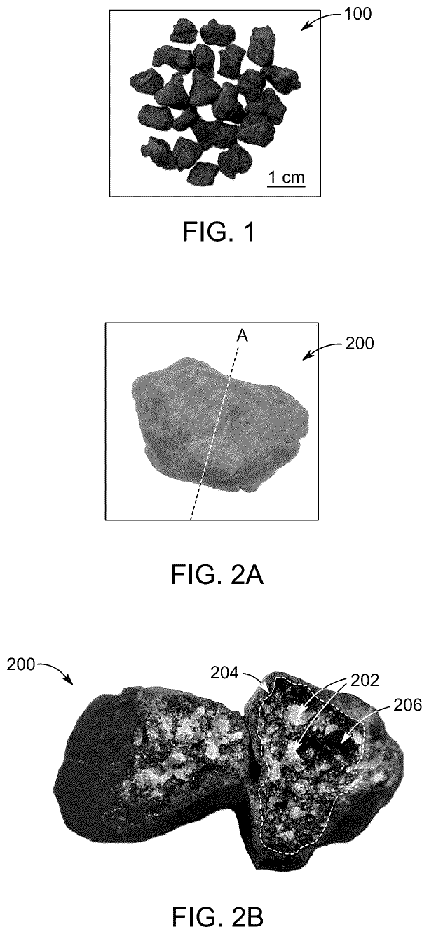

FIG. 1 provides a pictorial depiction of the SCP particles of the SCP composite (as represented by reference numeral 100), for the lightweight cement composition of the present disclosure. As shown, in the SCP composite 100, the SCP particles are shaped as polyhedrons. In some embodiments, the SCP particles has the average particle size ranging from 0.5 to 2 cm in their longest dimension. This specific shape and size are strategically implemented to optimize integration of the SCP composite within the matrix of the resulting concrete. The polyhedral shape may allow for better interlocking and distribution within the resulting concrete, enhancing the overall structural integrity and consistency of the mix. Further, this particle size range ensures an effective balance between the physical properties of the SCP composite and its ability to function as a phase change material within the resulting concrete, contributing to the thermal efficiency and structural stability of the final product.

In an embodiment, the cement shell of the FS-PCM composite has an average thickness of 0.01 to 5 millimeters (mm), preferably 0.02 to 4 mm, preferably 0.04 to 3 mm, preferably 0.06 to 2 mm, preferably 0.08 to 1 mm, or even more preferably 0.1 to 1 mm. Other ranges are also possible. This thickness range is set to ensure optimal protection of the SCP composite while maintaining the lightweight nature of the FS-PCM composite, in other words for the CA. The thickness of the cement shell ensures that the structural integrity of the FS-PCM composite within the lightweight cement composition effectively prevents the leakage of the phase change material therein, while maintaining the phase change properties of the lightweight cement composition. Additionally, the specified thickness range balances the need for stability without adding to the weight of the FS-PCM composite, thus preserving the lightweight characteristics of the lightweight cement composition.

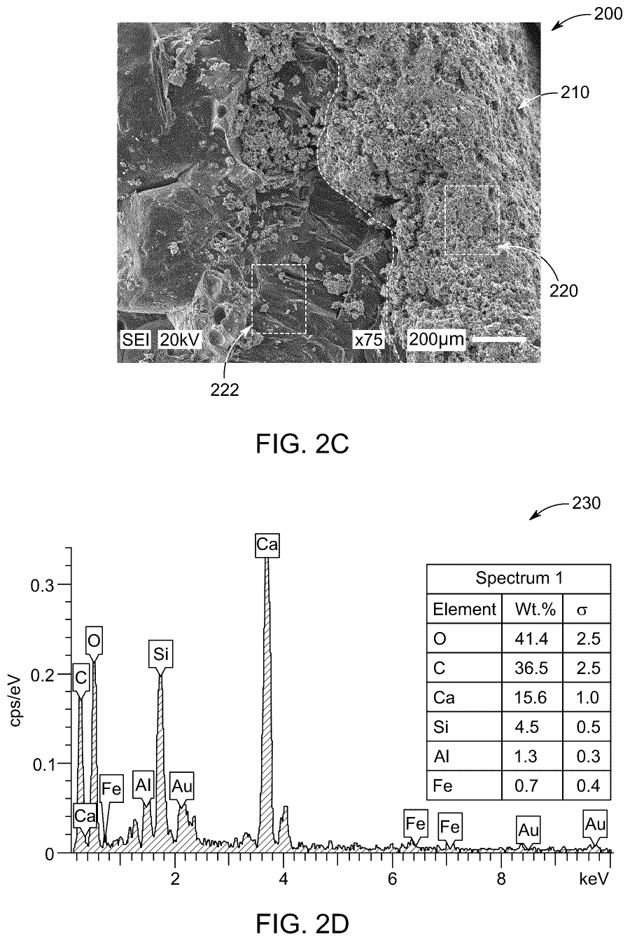

FIG. 2A provides a pictorial depiction of the CA or the FS-PCM composite (as represented by reference numeral 200), for the lightweight cement composition of the present disclosure. Herein, as discussed, the FS-PCM composite 200 has the core of the SCP composite (such as, the SCP composite 100 of FIG. 1) and the cement shell. FIG. 2B provides a pictorial depiction of the FS-PCM composite 200 split (sliced) in two parts, divided across a section A of FIG. 2A. As may be seen, the SCP composite (as represented by reference numeral 202 herein) is encapsulated by the cement shell (as represented by reference numeral 204). As may be seen, the cement shell 204 creates a barrier around the SCP composite 202 that results in the encapsulation of the phase change material therein and may prevent it from leakage. Herein, the cement shell 204 has a thickness of about 0.5 mm. This highlights the symbiotic relationship between the SCP composite 202 and the cement shell 204 to enhance the thermal and structural properties of the lightweight cement composition.

In an embodiment, the SCP composite comprises 10 to 50 wt. %, preferably 15 to 45 wt. %, preferably 20 to 40 wt. %, preferably 25 to 35 wt. %, or even more preferably about 30 wt. % of polyethylene glycol (PEG) based on a total weight of the SCP composite. Other ranges are also possible. In some embodiments, the SCP composite comprises 50 to 90 wt. %, preferably 55 to 85 wt. %, preferably 60 to 80 wt. %, preferably 65-75 wt. %, or even more preferably about 70 wt. % of scoria based on the total weight of the SCP composite. Other ranges are also possible. In some embodiments, the PEG at least partially penetrates voids in the porous scoria. That is, the SCP composite, as part of the FS-PCM composite, contains a specific proportion of its constituents, with 25-35 wt. % consisting of the PEG and 65-75 wt. % consisting of the scoria, based on the total weight of the SCP composite. In some embodiments, the PEG, known for its phase change properties, enables the SCP composite to absorb and store thermal energy efficiently. This energy is later released for temperature regulation within concrete structures. The interaction between the PEG and the scoria, where the PEG at least partially penetrates the voids of the porous scoria, maximizes the thermal efficiency of the SCP composite. An exemplary distribution of the PEG (as part of the SCP composite 202) within the scoria (as represented by reference numeral 206) may also be seen in the depiction of FIG. 2B, emphasizing how the PEG permeates porosity of the scoria 206.

FIG. 2C provides a detailed pictorial depiction of the FS-PCM composite 200 (specifically, a surface along the section A) as taken from a scanning electron micrograph (SEM) or the like. The detailed pictorial depiction of FIG. 2C shows the formation of a dense calcium-silicate-hydrate (C-S-H) gel (as represented by reference numeral 210) within the cement shell 204. This C-S-H gel is integral to ability of the SCP composite to encapsulate the PEG, especially during the melting process, preventing its leakage. The detailed pictorial depiction of FIG. 2C highlights the intricate microstructure of the FS-PCM composite 200 which aids in its performance for thermal energy storage and for structural stability within the lightweight cement composition.

Further, FIGS. 2D and 2E provide Energy-Dispersive X-ray Spectroscopy (EDS) spectra for a first region 220 and a second region 222, respectively, in the detailed pictorial depiction of the FS-PCM composite 200 of FIG. 2C. As used herein, an “EDS spectrum” is a graphical representation of the elemental composition of the material obtained through EDS analysis, which provides a fingerprint of the elements present in the material, including details of elements and relative quantity of each present element. Herein, a first spectrum 230 of FIG. 2D, corresponding to the first region 220, shows the presence of elements such as oxygen, calcium, silicon, aluminum, and iron, indicative of composition of the C-S-H gel within the cement shell 204. In contrast, a second spectrum 232 of FIG. 2E, corresponding to the second region 222, predominantly shows peaks for oxygen and carbon, which aligns with the elemental signature of the PEG (as part of the SCP composite 202), confirming its presence within the FS-PCM composite 200.

In an embodiment, the SCP composite has a specific gravity of 1 to 2.6, preferably 1.2 to 2.4, preferably 1.4 to 2.2, preferably 1.6 to 2.0, or even more preferably about 1.8, as determined by ASTM C127 (Standard Test Method for Relative Density (Specific Gravity) and Absorption of Coarse Aggregate, ASTM C127, which is incorporated herein by reference in its entirety). In an embodiment, the SCP composite has a water absorption of 3 to 8%, preferably 3.5 to 7.5%, preferably 4 to 7%, preferably 4.5 to 6.5%, preferably 5 to 6%, or even more preferably about 5.5% based on a total weight of the SCP composite, as determined by ASTM C127. The SCP composite, as defined within the lightweight cement composition, possesses the specific gravity of about 1.8 indicates a density that is favorable for structural stability while maintaining a lighter weight compared to traditional aggregates. Further, the water absorption capacity of the SCP composite being measured at about 5.5%, based on the total weight of the SCP composite, as per ASTM C127 standards, shows that the SCP composite can absorb sufficient moisture for the curing process without becoming oversaturated, which helps in maintaining the integrity of the FS-PCM composite. These properties impact the handling, mixing, and final properties of the lightweight cement composition, ensuring that it meets the desired performance criteria for a wide range of construction applications.

In an embodiment, the PEG has an average molecular weight of about 1000 to 50,000 g/mol, preferably about 1500 to 30,000 g/mol, or even more preferably about 2000 to 10,000 g/mol. Other ranges are also possible. In one embodiment, the specification that the PEG in the SCP composite has the average molecular weight of about 2000 to 10,000 g/mol ensures that the desired phase change behavior within the lightweight cement composition. This molecular weight range is selected to balance the thermal storage capacity and physical stability of the PEG. A higher molecular weight PEG typically has a higher melting point, which is beneficial for storing thermal energy at higher temperatures. Conversely, a lower molecular weight PEG will have a lower melting point, suitable for applications requiring thermal energy release at lower temperatures. This molecular weight range allows for versatility in application, ensuring that the SCP composite can be tailored to specific temperature ranges for optimal thermal energy storage and release in the lightweight cement composition.

In an embodiment, the scoria has a specific gravity of about 1 to 2, preferably 1.2 to 1.8, preferably 1.4 to 1.6, or even more preferably about 1.5, as determined by ASTM C127. Other ranges are also possible. In an embodiment, the scoria has a water absorption of about 5 to 20%, preferably 7 to 17%, preferably 9 to 14%, or even more preferably about 11% based on a total weight of the scoria, as determined by ASTM C127. In a preferred embodiment, the scoria utilized in the SCP composite is selected for its specific gravity of about 1.5, which may contribute to the lightweight characteristic of the lightweight cement composition. Additionally, the water absorption of about 11% based on the total weight of the scoria, as certified by ASTM C127, shows porosity of the lightweight cement composition. This porosity helps in the impregnation process with the PEG, allowing for the scoria to act as a reservoir for the phase change material. This provides thermal energy storage and regulation capabilities to the SCP composite within the lightweight cement composition.

In an embodiment, the scoria has a thermal conductivity of about 0.05 to 0.5 W/mK, preferably 0.1 to 0.4 W/mK, preferably 0.15 to 0.3 W/mK, preferably 0.2 to 0.3 W/mK, or even more preferably about 0.27 W/mK. Other ranges are also possible. In a preferred embodiment, the scoria in the SCP composite, with its thermal conductivity of about 0.27 W/mK, provides the required thermal performance to the lightweight cement composition. This relatively low thermal conductivity signifies effectiveness of the scoria as an insulating component within the lightweight cement composition, reducing the rate of heat transfer through the material. This property is beneficial in maintaining the thermal energy storage capacity of the PEG, ensuring that the absorbed heat is not dissipated quickly and can be released in a controlled manner, contributing to the energy efficiency of structures constructed with the lightweight cement composition.

In an embodiment, the cement shell is made of Type I ordinary portland cement (OPC), and wherein the OPC meets ASTM C150. As used herein, the ‘ASTM C150’ is a standard specification in the construction industry, focusing on Portland Cement, which establishes the requirements for its composition, physical and chemical properties, and performance tests. This standard ensures that the cement composition possesses the necessary properties for general construction use, including adequate strength and durability. The use of Type I OPC for the cement shell provides the FS-PCM composite with structural stability, ensuring the PEG within the scoria does not leak and the thermal energy storage capacity of the FS-PCM composite is maintained effectively within the lightweight cement composition.

The present disclosure further provides a cured specimen (not illustrated in the accompanied drawings) made from the lightweight cement composition, with the cured specimen having a compressive strength of 3 to 30 MPa. In other words, this specimen, once cured, achieves the compressive strength between 3 to 30 MPa, which signifies its suitability for a broad array of structural applications. The given range of the compressive strength allows the cured specimen to be utilized in both non-loadbearing and load-bearing scenarios, from interior applications to structural components of buildings, offering a sustainable alternative to traditional concrete with the added benefit of energy conservation.

The present disclosure further provides a cured specimen (not illustrated in the accompanied drawings) made from the lightweight cement composition, with the cured specimen having a thermal conductivity of 1 to 1.6 watts per meter-kelvin (W/mK). In other words, this specimen, once cured, exhibits the thermal conductivity between 1 to 1.6 W/mK, which signifies its effectiveness in thermal management, balancing the need for insulating properties with the ability to release stored thermal energy when required. The given range of the thermal conductivity makes the cured specimen suitable for applications where temperature moderation is required for energy conservation, providing a significant advantage over traditional construction materials that lack such thermal efficiency.

In the present disclosure, the CA may further comprise a crushed limestone. As used herein, limestone refers to a sedimentary rock composed largely of the minerals calcite and aragonite, which are different crystal forms of calcium carbonate (CaCO₃). Limestone is naturally occurring and can be found in skeletal fragments of marine organisms such as coral, forams, and molluscs. Crushed limestone is generated during the crushing and grinding of limestone rocks. The crushed limestone used herein may have an average particle size greater than 1 mm. In one embodiment, the crushed limestone has an average particle size of 1.5-32 mm, preferably 2-30 mm, preferably 4-28 mm, preferably 6-24 mm, preferably 8-20 mm, preferably 10-18 mm, preferably 12-16 mm. The crushed limestone may contain materials including, but not limited to, calcium carbonate, silicon dioxide, quartz, feldspar, clay minerals, pyrite, siderite, chert, and other minerals. In some embodiments, the coarse aggregate has a specific gravity of 2.2 to 2.8, and a maximum particle size of at most 20 mm, preferably at most 18 mm, or even more preferably at most 16 mm. In a specific embodiment, the coarse aggregate has a specific gravity of preferably 2.2, preferably 2.3, preferably 2.4, preferably 2.5, and a maximum particle size of at most 20 mm, preferably at most 18 mm, or even more preferably at most 16 mm. In a most preferred embodiment, the coarse aggregate of the cement composition is crushed limestone with a specific gravity of 2.1-3.0, preferably 2.2-2.8, more preferably 2.4-2.7, or about 2.56. Other ranges are also possible.

The lightweight cement composition may further optionally include an alkaline component in an amount of 0.01 to 10 wt. %, based on the total weight of the lightweight cement composition, preferably 3 to 8 wt. %, or even more preferably 5 to 6 wt. % based on the total weight of the lightweight cement composition. Alkali activation generally releases reactive species (e.g., CaO) from the binder, thus increasing the rate of densification and improving the microstructural strength of the binder, which by extension affects the mechanical properties and durability performance of the cured lightweight cement composition. The alkali activator may be a mixture of an aqueous solution of a metal hydroxide, preferably an alkali metal hydroxide (e.g., sodium hydroxide, potassium hydroxide, etc.), and a metal silicate, preferably an alkali metal silicate (e.g., sodium silicate, potassium silicate, etc.). In some embodiments, the alkali activator may be an aqueous solution of a metal hydroxide, preferably an alkali metal hydroxide. In preferred embodiments, the alkali activator is an aqueous mixture of sodium hydroxide and sodium silicate. Preferably, the alkali activator consists of sodium hydroxide and sodium silicate in water. In some more preferred embodiments, a weight ratio of NaOH to the Na₂SiO₃ may generally range from 1:1 to 1:4, preferably 1:1.5 to 1:3.5, preferably 1:2 to 1:3, or even more preferably about 1:2.5. Other ranges are also possible.

The lightweight cement composition may further optionally include a plasticizer in an amount of 0.001 to 2 wt. % based on the total weight of the lightweight cement composition. The plasticizer includes at least one from the group consisting of a lignosulfonate plasticizer, a polycarboxylate ether plasticizer, a melamine plasticizer, and a naphthalene plasticizer. In some embodiments, the plasticizer is a combination of two or more plasticizers selected from the above group. In some specific embodiments, the plasticizer is a combination of one or more plasticizers included from the above group with an organic non-volatile compound.

As used herein, a “plasticizer” is an additive that increases the plasticity or fluidity of the cement slurry. Plasticizers increase the workability of “fresh” lightweight cement composition, allowing it to be placed and consolidated more easily, with less effort. A superplasticizer is a plasticizer with fewer deleterious effects. A “superplasticizer” refers a chemical admixture used herein to provide a well-dispersed particle suspension in the wet lightweight cement composition. The superplasticizer may be used to prevent particle segregation and to improve the flow characteristics of the wet lightweight cement composition. The superplasticizer may be a polycarboxylate, e.g., a polycarboxylate derivative with polyethylene oxide side chains, a polycarboxylate ether (PCE), such as the commercially available Glenium 51®. Polycarboxylate ether superplasticizers may allow a significant water reduction at a relatively low dosage, thereby providing good particle dispersion in the wet sand slurry. Polycarboxylate ether superplasticizers are composed of a methoxy-polyethylene glycol copolymer (side chain) grafted with methacrylic acid copolymer (main chain). Exemplary superplasticizers that may be used in addition to, or in lieu of a polycarboxylate ether superplasticizer include, but are not limited to, alkyl citrates, sulfonated naphthalene, sulfonated alkene, sulfonated melamine, lignosulfonates, calcium lignosulfonate, naphthalene lignosulfonate, polynaphthalenesulfonates, formaldehyde, sulfonated naphthalene formaldehyde condensate, acetone formaldehyde condensate, polymelaminesulfonates, sulfonated melamine formaldehyde condensate, polycarbonate, other polycarboxylates, other polycarboxylate derivatives comprising polyethylene oxide side chains, and the like and mixtures thereof. In a preferred embodiment, the lightweight cement composition has a weight percentage of the plasticizer ranging from 0.1-3.0% relative to the total weight of the lightweight cement composition, preferably 0.2-2.5%, preferably 0.5-2.0%, preferably 1.0-1.8%, preferably 1.2-1.6%, or about 1.5% relative to the total weight of the lightweight cement composition. Other ranges are also possible.

In an embodiment, the lightweight cement composition may further optionally include a surfactant. In a preferred embodiment, the surfactant may be a nonionic surfactant, an anionic surfactant, a cationic surfactant, a viscoelastic surfactant, or a zwitterionic surfactant. The surfactants may include, but are not limited to, ammonium lauryl sulfate, sodium lauryl sulfate (SLS), sodium dodecyl sulfate (SDS), alkyl-ether sulfates, sodium laureth sulfate, sodium lauryl ether sulfate (SLES), sodium myreth sulfate, docusate (dioctyl sodium sulfosuccinate), perfluorooctanesulfonate (PFOS), perfluorobutanesulfonate, alkyl-aryl ether phosphates, alkyl ether phosphates, octenidine dihydrochloride; cetrimonium bromide (CTAB), cetylpyridinium chloride (CPC), benzalkonium chloride (BAC), benzethonium chloride (BZT), dimethyldioctadecylammonium chloride, dioctadecyldimethylammonium bromide (DODAB), CHAPS (3-[(3-cholamidopropyl)dimethylammonio]-1-propanesulfonate), cocamidopropyl hydroxysultaine, ocamidopropyl betaine, phospholipids, and sphingomyelins. In a preferred embodiment, the lightweight cement composition has a weight percentage of the surfactant ranging from 0.1-3.0% relative to the total weight of the composition, preferably 0.2-2.5%, preferably 0.5-2.0%, preferably 1.0-1.8%, preferably 1.2-1.6%, or about 1.5% relative to the total weight of the lightweight cement composition. Other ranges are also possible.

The surfactant may include primary and secondary emulsifiers. Hereinafter, the primary and secondary emulsifiers are collectively referred to as the “emulsifiers” or “surfactants” and individually referred to as the “emulsifier” or “surfactant,” unless otherwise specified. The primary emulsifier is a polyaminated fatty acid. The primary emulsifier includes a lower hydrophilic-lyophilic balance (HLB) in comparison to the secondary emulsifier. The primary emulsifier may include, but are not limited to, span 60, span 85, span 65, span 40, and span 20. The primary emulsifier is sorbitan oleate, also referred to as the span 80. The secondary emulsifiers may include, but are not limited to triton X-100, Tween™ 80, Tween™ 20, Tween™ 40, Tween™ 60, Tween™ 85, OP4 and OP 7. The secondary emulsifier includes a biosurfactant, such as a rhamnolipid surfactant. In an embodiment, the surfactant may be neopelex or stearic acid.

The lightweight cement composition may further optionally include a defoaming agent. As used herein, the term “deforming agent” refers to the chemical additive that reduces and hinders foam formation in industrial process liquids. The deforming agent may include, but is not limited to, 2-octanol, oleic acid, paraffinic waxes, amide waxes, sulfonated oils, organic phosphates, silicone oils, mineral oils, and dimethylpolysiloxane. The defoaming agent may be dimethyl silicone polymer or polyoxy propylene glycerin ether. In a preferred embodiment, the lightweight cement composition has a weight percentage of the defoaming agent ranging from 0.01-1.0% relative to the total weight of the lightweight cement composition, preferably 0.02-0.8%, preferably 0.03-0.6%, preferably 0.04-0.4%, preferably 0.05-0.2%, or about 0.1% relative to the total weight of the lightweight cement composition.

The present disclosure further provides a cured specimen (not illustrated in the accompanied drawings) made from the lightweight cement composition, with the cured specimen having a thermal resistivity of 0.1 to 5 m²K/W, preferably 0.2 to 4 m²K/W, preferably 0.4 to 3 m²K/W, preferably 0.6 to 2 m²K/W, or even more preferably 0.8 to 1.5 m²K/W. Other ranges are also possible. In some preferred embodiments, this specimen, once cured, exhibits the thermal resistivity between 0.8 to 1.5 m²K/W, which signifies its capability to resist the flow of heat through it, contributing to the energy efficiency of buildings where temperature control is required. The given range of the thermal resistivity provides desired insulation properties to the cured specimen and makes the cured specimen suitable for use in eco-friendly construction practices that demand high energy conservation standards.

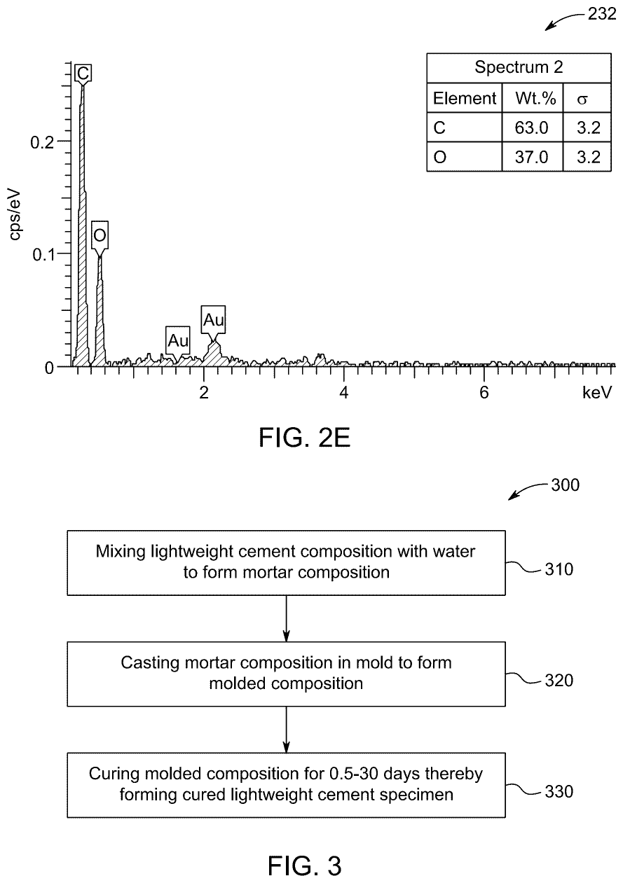

Referring to FIG. 3, the present disclosure further provides a method (as represented by a flowchart, referred by reference numeral 300) of making a cured lightweight cement specimen. The “cured lightweight cement specimen” in the context of the method 300 refers to the end product obtained after the lightweight cement composition has undergone a curing process. The term ‘cured’ signifies that the cement has achieved a sufficient level of hydration and strength, while ‘lightweight’ indicates that the density of the cement is reduced due to the specific aggregates used in the lightweight cement composition. The cured lightweight cement specimen is thus characterized by its reduced mass and improved thermal properties compared to conventional concrete.

The method 300 of the present disclosure utilizes the lightweight cement composition (as discussed in the preceding paragraphs) and encompasses a series of steps to form the cured lightweight cement specimen. These steps are only illustrative, and other alternatives can also be provided where one or more steps are added, one or more steps are removed, or one or more steps are provided in a different sequence without departing from the scope of the claims herein. Various embodiments and variants disclosed above, with respect to the aforementioned lightweight cement composition apply mutatis mutandis to the method 300 of brewing coffee, as discussed in the proceeding paragraphs.

At step 310, the method 300 includes mixing the lightweight cement composition with water to form a mortar composition. This stage initiates the chemical reaction necessary for the curing process. Herein, a proper ratio of the water to the lightweight cement composition is utilized to achieve a desired consistency, workability, and final strength of the mortar composition. At step 320, the method 300 includes casting the mortar composition in a mold to form a molded composition. This stage shapes the mortar composition into a desired form or structure, defining the physical dimensions of the cured lightweight cement specimen. The mold used can vary depending on the specific application or architectural requirements, allowing for flexibility in the design and usage of the mortar composition in construction projects. At step 330, the method 300 includes curing the molded composition for 0.5-30 days, preferably 1 to 25 days, preferably 2 to 20 days, preferably 3 to 15 days, preferably 4 to 10 days, or even more preferably about 5 days, thereby forming the cured lightweight cement specimen. Other ranges are also possible. This stage develops strength and durability in the lightweight cement composition. During this period, the hydration reactions within the lightweight cement composition progress, leading to the hardening and strengthening of the composite material. The length of the curing time can be adjusted based on the specific requirements, for achieving the final properties of the cured lightweight cement specimen.

In an embodiment, the water is at least one selected from the group consisting of tap water, ground water, distilled water, deionized water, fresh water, and desalted water. That is, the type of water used for mixing with the lightweight cement composition is varied and includes options such as the tap water, the ground water, the distilled water, the deionized water, the fresh water, and the desalted water. This flexibility in water selection allows the method 300 to be adaptable to different environmental and resource availability conditions, ensuring that the process can be implemented in various locations and contexts. It may be noted that each type of water brings specific properties that can influence the hydration process and the final characteristics of the cured lightweight cement specimen.

In an embodiment, a weight ratio of water to the curable component present in the lightweight cement composition is in a range of 0.1:1 to 1:1, preferably 0.2:1 to 0.8:1, or even more preferably 0.4:1 to 0.6:1. Other ranges are also possible. That is, for making the cured lightweight cement specimen, the weight ratio of water to the curable component is determined to be within the range of 0.4:1 to 0.6:1. As discussed, the curable component in the lightweight cement composition typically includes materials such as portland cement, pozzolan cement, gypsum cement, aluminous cement, silica cement, and alkaline cement. These components are required for hardening process and contribute to its structural integrity and durability of the resulting concrete. This specific weight ratio ensures an optimal balance between the water and curable component for achieving the right consistency and hydration necessary for it to cure properly. The ratio is selected to optimize the curing process, leading to a final product with the desired mechanical and thermal properties.

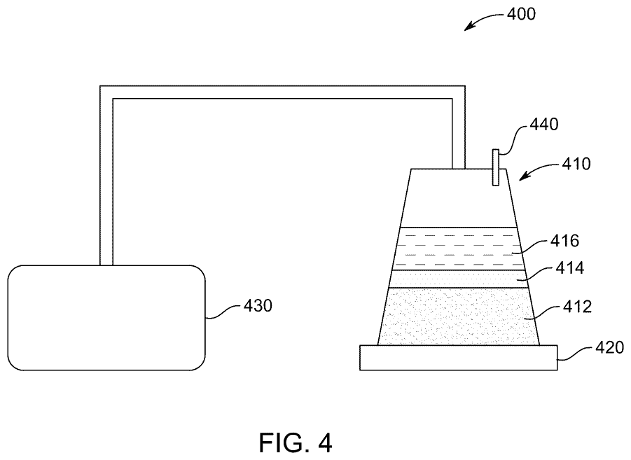

In an embodiment, the method 300 further comprises preparing the SCP composite by placing particles of scoria in a chamber under a vacuum for an appropriate amount of time; introducing PEG into the chamber in contact with the particles of scoria and heating in the vacuum environment to form a crude scoria composite; and removing an excessive amount of PEG from the crude scoria composite by drying to form the SCP composite. Referring to FIG. 4, illustrated is a set-up (as represented by reference numeral 400) to be implemented for preparing the SCP composite as per the described process. Herein, initially, the particles of scoria (as represented by reference numeral 412, and also referred to as “scoria 412” and “porous scoria 412”) are first placed in a chamber 410 having a vacuum created by a vacuum pump 430 connected thereto. As shown, the chamber 410 may be implemented in the form of a conical vessel. Further, the PEG (as represented by reference numeral 414) is introduced into the chamber 410 to make contact with the particles of scoria 412. The vacuum environment removes air and moisture from the porous scoria 412, preparing it to be impregnated with the PEG 414. The time spent under vacuum is calibrated to ensure complete evacuation of air from the pores of scoria 412 particles without damaging its structure. The combination is then heated, using a heating plate 420 or the like, within this vacuum environment. This step facilitates penetration of the PEG 414 into pores/voids of the particles of scoria 412, forming the crude scoria composite. The heating conditions, including temperature and duration, as may be regulated by use of a thermometer 440, ensures effective impregnation of the PEG 414 into the scoria 412. The final step involves removing the excessive amount of the PEG 414 from the crude scoria composite. This is achieved through a drying process, which solidifies the PEG 414 within the scoria 412, resulting in the SCP composite. The drying process achieves the correct balance of the PEG 414 within the scoria 412, ensuring effectiveness of the SCP composite as a phase change material within the lightweight cement composition. The formed lightweight cement composition may then be mixed with water (as represented by reference numeral 416), using the set-up 400 itself, to form the mortar composition (as discussed).

In an embodiment, the heating is performed at a temperature of 50 to 90 degrees Celsius (° C.), preferably 60 to 80° C., or even more preferably at about 70° C., under a pressure of about 0.05 to 0.2 MPa, preferably 0.08 to 0.15 MPa, or even more preferably about 0.1 MPa. Other ranges are also possible. In a preferred embodiment, the heating process during the SCP composite preparation is conducted at a controlled temperature ranging from 50 to 90° C., under a specific pressure range of about 0.05 to 0.2 MPa. This combination of temperature and pressure is chosen to optimize the impregnation of the PEG into the scoria, ensuring effective absorption and distribution of the phase change material within the porous structure of the scoria. The controlled environment results in the formation of the SCP composite with desired thermal properties.

In an implementation, the preparation of the SCP composite involved vacuum impregnation under a pressure of 0.1 MPa. Initially, the scoria particles are placed in the chamber, followed by the addition of solid polyethylene glycol (PEG). A vacuum pressure of 0.1 MPa is then applied for 10 minutes. The chamber is subsequently heated in a water bath at 70° C. for two hours, allowing the PEG to melt and permeate the scoria's porosity. This process, confirmed by the absence of air bubbles, resulted in the scoria being fully saturated with the PEG. The chosen conditions of two hours and 0.1 MPa pressure are determined to be optimal for forming the SCP composite.

The method 300 of the present disclosure further comprises constructing a building by aligning a plurality of cured lightweight cement specimens in side-by-side alignment to form a structural element of the building. The cured lightweight specimens, developed from the lightweight cement composition of the present disclosure, are uniquely characterized by their reduced weight, enhanced thermal properties, and sufficient structural strength. In the construction process, these specimens are aligned side by side, forming a structural element within the building. This alignment ensures that the individual properties of each specimen contribute collectively to the overall stability, thermal efficiency, and energy performance of the building. The side-by-side arrangement of these cured specimens allows for the creation of a continuous structural element, effectively leveraging the individual strengths of each specimen to achieve greater structural integrity and insulation.

The use of the lightweight cement specimens in building construction offers significant advantages. Their lightweight nature reduces the overall load on foundation and other structural components of the building, making them particularly useful in areas where weight is a critical factor. Additionally, their enhanced thermal properties contribute to energy efficiency of the building, potentially reducing the need for additional insulation materials. Furthermore, the use of these specimens in construction makes the process more environmentally-friendly compared to the traditional materials. The energy-efficient nature of the specimens can contribute to reducing the overall carbon footprint of the building, aligning with contemporary sustainable building practices.

The lightweight cement composition is applicable for a diverse range of construction applications. The lightweight cement composition integrates durability with environmental-sustainability, catering to the demands of modern construction practices. The lightweight cement composition possesses properties that can enhance energy management within structures, thereby reducing the necessity for external heating and cooling systems.

### EXAMPLES

The present disclosure relates to the development of thermal energy storage concrete by replacing scoria aggregates with cement-coated scoria/polyethylene glycol composite phase change material as coarse aggregate in concrete. Scoria aggregate was impregnated with Polyethylene glycol (PEG) using the vacuum impregnation technique. The composite SCP was coated with Portland cement mortar (SCPC) at certain ratios to encapsulate and prevent the leakage of PEG from the SC. The form-stabilized phase change material (FS-PCM) of the present disclosure was used in concrete for thermal energy storage. The normal scoria used in concrete may be replaced by SCPC at different levels, adding new functionality to the concrete to store thermal energy. The constituents in a traditional lightweight concrete are shown in Table 1 below.

TABLE 1
Constituents of a lightweight concrete (MSC).

| | Cement | FA | Scoria | SCPC | Water |
|---|---|---|---|---|---|
| Ingredient (kg/m³) | 400 | 854 | 569 | 0 | 228 |

The preparation of cement paste to develop SCPC was started initially by selecting the optimum SCP to cement (SCP:C) ratio by preparing several trial mixtures. The selection of optimum SCP:C ratio ensures that all the SCP particles are coated uniformly without excess cement paste. The water to cement ratio of the cement paste was fixed at, e.g., preferably about 0.35 for all the trial mixtures. First, the cement was mixed with water for, e.g., preferably about 5 minutes till the cement paste was homogenous. Thereafter, the SCP particles were added to the cement paste and mixed for another 5 minutes till they were covered with cement paste. Finally, the SCPC particles were segregated and dried at room temperature for, e.g., preferably about 24 hours. After preparation of SCPC, its specific gravity and water absorption was calculated according to ASTM C127. The water absorption and specific gravity of SCPC are about 5.5% and about 1.8, respectively.

A water to cement ratio (w/c) of, e.g., preferably about 0.4, and fine aggregate to total aggregate ratio (FA/TA) of, e.g., preferably about 0.6, were used in the preparation of TESC mixtures. These values were selected to be consistent with the reference concrete mixture. Concrete mixtures were prepared with five different percentages of SCPC used as replacement of SC. Table 2 (below) shows the composition of concrete mixtures prepared with SCPC.

TABLE 2
Composition of concrete mixtures prepared with SCPC.

| | Ingredient (kg/m³) | | | | |
|---|---|---|---|---|---|
| | | | Coarse | | |
| Specimen | | Fine | aggregate | | |
| designation | Cement | aggregate | (Scoria) | SCPC | Water |
| M20SCPC | 400 | 869 | 464 | 116 | 223 |
| M40SCPC | 400 | 885 | 354 | 236 | 217 |
| M60SCPC | 400 | 902 | 241 | 361 | 212 |
| M80SCPC | 400 | 919 | 123 | 490 | 206 |
| M100SCPC | 400 | 937 | 0 | 625 | 200 |

The nomenclature utilized to identify the composition of concrete is as follows:
1. M20SCPC: 20% replacement of SC by SCPC.
2. M40SCPC: 40% replacement of SC by SCPC.
3. M60SCPC: 60% replacement of SC by SCPC.
4. M80SCPC: 80% replacement of SC by SCPC.
5. M100SCPC: 100% replacement of SC by SCPC.

Herein, the material used include the PEG with the molecular weight of ultrapure (purity >99%) polyethylene glycol 6000. The specific gravity of scoria was about 1.5 and its thermal conductivity and water absorption were about 0.27 W/m·K and about 11%, respectively. Ordinary Portland cement (OPC), classified as Type I by ASTM C150, with a unit weight of 3150 kg/m³ was used in coating the SC and the preparation of concrete specimens. Fine sand with a specific gravity of 2.56 and water absorption of 0.60% by weight was used as fine aggregate in the preparation of concrete specimens.

The developed thermal energy storage concrete (TESC) was tested to determine its mechanical and thermal properties. The performance of the developed TESC was compared with that of conventional concrete (without PEG). The developed TESC exhibited superior mechanical and thermal properties and as such its use will have a tremendous environmental impact, as its use will lead to lower energy consumption in buildings.

The developed concrete specimens were tested to determine compressive strength, thermal conductivity, and thermal performance. The compressive strength results are presented in Table 3 below.

TABLE 3
Compressive strength of reference and developed SCPC mixtures.

| Age of | Compressive strength, MPa | | | | | |
|---|---|---|---|---|---|---|
| testing, days | MSC | M20SCPC | M40SCPC | M60SCPC | M80SCPC | M100SCPC |
| 3 | 20.42 | 14.32 | 10.59 | 8.52 | 5.52 | 4.78 |
| 7 | 22.96 | 19.59 | 16.13 | 14.89 | 9.14 | 7.28 |
| 14 | 27.73 | 24.44 | 19.57 | 18.20 | 13.37 | 11.45 |
| 28 | 31.21 | 28.66 | 24.09 | 22.79 | 18.22 | 16.84 |

The compressive strength of Modified Scoria Concrete (MSC) was tested. The early age strength of MSC was relatively more than that of SCPC mixtures. This may be attributed to the weaker bond between the SCPC particles in concrete mix, in addition to the presence of PEG which reduces the overall strength of concrete. However, based on the 28-day compressive strength, all the mixtures, except mixture M100SCPC, can be used as a structural concrete according to the American Concrete Institute (ACI) requirements of 2500 psi (17.2 MPa) (ACI Committee, 318. Building Code Requirements for Structural Concrete and Commentary (ACI 318R-19; 2019, incorporated herein by reference in its entirety). Nevertheless, mixture M100SCPC can be used as a non-structural concrete in masonry construction.

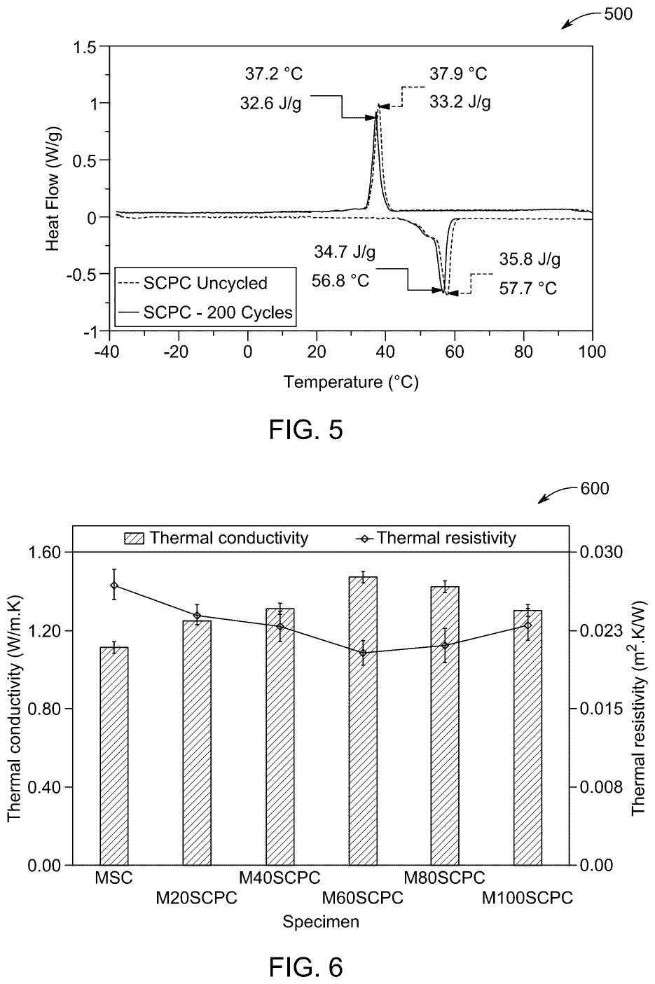

The thermal reliability of SCPC particles was tested by subjecting them to 200 thermal cycles. The results of DSC, as depicted in graph 500 of FIG. 5 showing DSC before and after 200 thermal cycles of SCPC composite, show that SCPC can maintain its structure even after vigorous thermal cycling. The SCPC concrete sustained 200 cycles of melting and solidification. Furthermore, after 200 thermal cycles, the variation in the phase change temperature and enthalpies of SCPC were insignificant. Therefore, it can be concluded that the developed SCPC has good thermal stability and can be deployed as a latent heat thermal energy storage (LHTES) material in concrete construction.

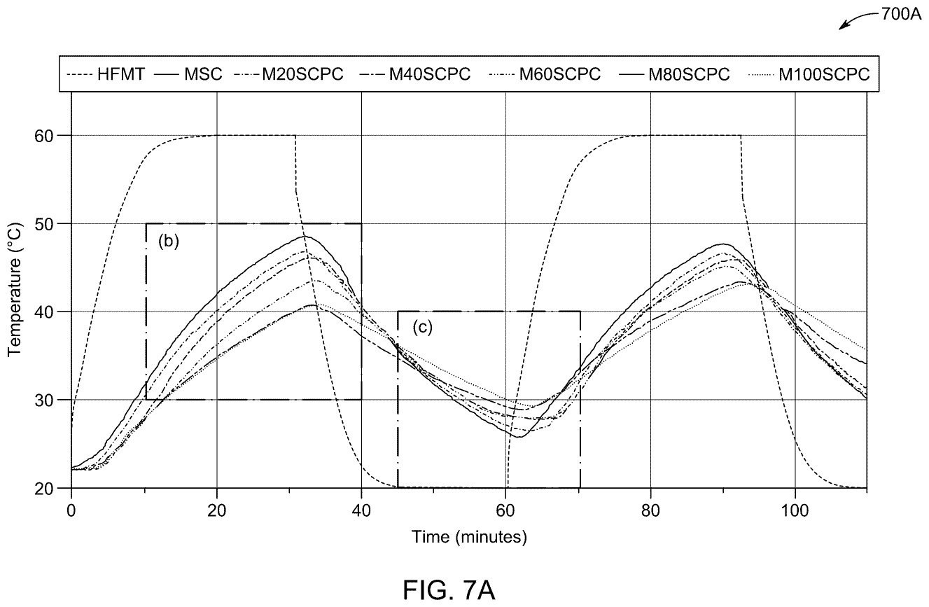

The thermal conductivity and thermal resistivity values of the concrete panels prepared with or without SCPC were calculated using HFM according to the following equations (“Thermtest.” HFM 100 Series—Thermal Conductivity Meter for Measurement of Insulation and Construction Materials. Sidilab 2020, incorporated herein by reference in its entirety):

$$λ = \frac{Q}{A} \times \frac{L}{Δ T} \qquad ( 1 )$$

$$R = \frac{1}{λ} \times L \qquad ( 2 )$$

Where, λ is the thermal conductivity, (W/m·K), Q/A is the measured heat flux; L is the sample thickness, ΔT is the temperature difference between the top and bottom plate at regular intervals and R is the thermal resistance (m²·K/W). The thermal conductivity and thermal resistivity for the reference and the developed SCPC mixtures are depicted in graph 600 of FIG. 6, showing thermal conductivity and thermal resistivity values of MSC and SCPC concrete mixtures.

Further, for thermal energy storage (TES) applications, a high thermal conductivity is preferred as low thermal conductivity delays the thermal response of a TES system. Therefore, the low thermal conductivity of SC and PEG are not desirable (Mohaisen, K. O.; Hasan Zahir, M.; Maslehuddin, M.; Al-Dulaijan, S. U. Development of a Shape-Stabilized Phase Change Material Utilizing Natural and Industrial Byproducts for Thermal Energy Storage in Buildings. Journal of Energy Storage 2022, 50 (January), 104205, incorporated herein by reference in its entirety). The low thermal conductivity of MSC may be attributed to the high porosity of SC. Conversely, the thermal conductivity of SCPC increased with an increase in replacement of SC by SCPC, this is due to the high thermal conductivity of cement paste used for the coating of SCP particles. The cement paste improved the thermal conductivity of M60SCPC by 30% compared to the MSC. Moreover, as PEG is more conductive than air (Mankel, C.; Caggiano, A.; Koenders, E. Thermal Energy Storage Characterization of Cementitious Composites Made with Recycled Brick Aggregates Containing PCM. Energy and Buildings 2019, 202, 109395, incorporated herein by reference in its entirety), the volume of PEG in the capillary pores of SC may cause a modest increase in the thermal conductivity of SCPC. However, the thermal conductivity decreased in the M80SCPC and M100SCPC specimens. This trend may be attributed to the higher amount of PEG that increased the thermal conductivity of concrete. Furthermore, the thermal conductivity of M100SCP was more than that of MSC specimens. It should be noted that the thermal resistivity, which was calculated using Equation (2) is inversely proportional to the thermal conductivity.

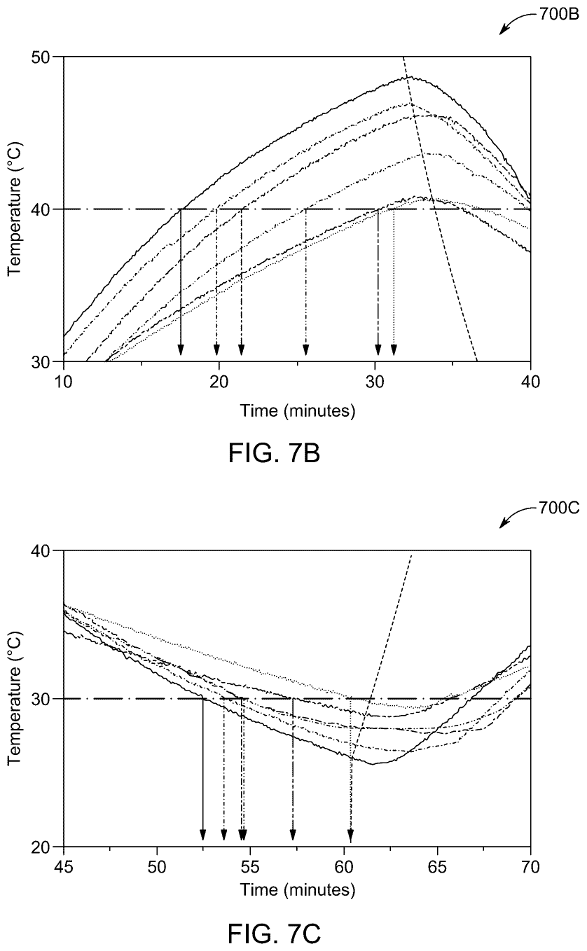

The thermal performance of the prepared concrete panels with/without SCPC were tested by considering the bottom surface temperature of the panels during both heating and cooling periods. The heat flow meter temperature (HFMT) of the heating plate was set to increase up to 60° C., then it was decreased to 20° C. for each thermal cycle. The bottom panel temperature was measured according to the temperature of the top HFM plate. As depicted in graph 700A of FIG. 7A, showing heating and cooling temperature profile cycles at the bottom plate of concrete panels, the increasing rates in the bottom surface temperature of the concrete panels were not similar. In other words, the passing time at a temperature of 40° C. was 17.6, 19.8, 21.3, 25.7, 30.1, and 31.1 minutes for MSC, M20SCPC, M40SCPC, M60SCPC, M80SCPC, and M100SCPC, respectively, as depicted in graphs 700B of FIGS. 7B and 700C of FIG. 7C, showing enlarged views of heating and cooling profiles of the graph 700A of FIG. 7A. Moreover, the maximum temperature obtained decreased with an increase in the quantity of SCPC in the concrete panels. In a broader context, the greater inclusion of SCPC yields a proportional mitigation of temperature elevation or reduction throughout both the heating and cooling sequences.

It may be noted that the attributes of the developed product include: (i) Scoria aggregates have lower unit weight that may decrease both the total weight and cost of the concrete produced; (ii) Cement coating is easy to apply, and it can encapsulate the PCM thereby preventing the leakage of PEG compared with epoxy coating and other complex encapsulation techniques; (iii) The developed SCPC mixtures satisfy the strength requirements for structural applications; and (iv) The improved thermal properties of the developed SCPC decrease the energy consumption in buildings which also results in lower carbon emission.

In conclusion, the utilization of porous volcanic scoria as a supporting matrix in the creation of a form-stable PCM (FS-PCM) has yielded improved results. The employment of a vacuum impregnation technique leads to an impressive PEG absorption capacity of 47%. The cement-coated SCP (SCPC) exhibited robust thermal stability, preserving the integrity of PEG even beyond its melting point. The SCPC maintained its energy storage capacity without any degradation even after 200 phase transition cycles. The cement coating concurrently heightened the thermal conductivity of the SCP, thereby increasing the thermal energy storage (TES) capability of concrete. The results of differential scanning calorimetry (DSC) affirmed that the energy storage capacity of SCPC composite increased by 97%. Thus, SCPC bears significant potential for elevating thermal storage efficiency of concrete. Herein, the concrete incorporating up to 80% SCPC maintained adequate compressive strength for structural applications. However, concrete with 100% SCPC can be used for non-structural applications with improved thermal efficiency. Thermal analysis showed that concrete panels with SCPC, exhibited considerable temperature reduction during heating and cooling cycles. A temperature reduction of up to 5.5° C. was recorded, showing the superior thermal inertia of SCPC-infused concrete. Consequently, the incorporation of SCPC promises substantial enhancements in building thermal performance, energy conservation, and load management.

Modifications and variations of the present disclosure are possible in light of the above teachings. It is therefore to be understood that within the scope of the appended claims, the invention may be practiced otherwise than as specifically described herein.

1: A lightweight cement composition, comprising:
a curable component in an amount of 15 to 25 wt. % based on a total weight of the lightweight cement composition;
a fine aggregate (FA) in an amount of 40 to 45 wt. % based on the total weight of the lightweight cement composition; and
a coarse aggregate (CA) in an amount of 3 to 30 wt. % based on the total weight of the lightweight cement composition;
wherein the CA comprises a form-stabilized phase change material (FS-PCM) composite comprising a core of scoria polyethylene glycol (SCP) composite and a cement shell.

2: The lightweight cement composition of claim 1, wherein the SCP composite has a specific gravity of about 1.8, and a water absorption of about 5.5% based on a total weight of the SCP composite, as determined by ASTM C127.

3: The lightweight cement composition of claim 1, wherein the SCP composite comprises SCP particles having a polyhedron shape and an average particle size of 0.5 to 2 centimeters (cm) in the longest dimension.

4: The lightweight cement composition of claim 1, wherein the cement shell of the FS-PCM composite has an average thickness of 0.1 to 1 millimeters (mm).

5: The lightweight cement composition of claim 1, wherein the cement shell is made of Type I ordinary portland cement (OPC), and wherein the OPC meets ASTM C150 requirements.

6: The lightweight cement composition of claim 1, wherein the SCP composite comprises:
25-35 wt. % of polyethylene glycol (PEG) based on a total weight of the SCP composite; and
65-75 wt. % of scoria based on the total weight of the SCP composite;
wherein the PEG at least partially penetrates voids in the porous scoria.

7: The lightweight cement composition of claim 6, wherein the PEG has an average molecular weight of about 2000 to 10,000 g/mol.

8: The lightweight cement composition of claim 6, wherein the scoria has a specific gravity of about 1.5, and a water absorption of about 11% based on a total weight of the scoria, as determined by ASTM C127.

9: The lightweight cement composition of claim 6, wherein the scoria has a thermal conductivity of about 0.27 W/mK.

10: The lightweight cement composition of claim 1, wherein the curable component comprises at least one selected from the group consisting of portland cement, pozzolan cement, gypsum cement, aluminous cement, silica cement, and alkaline cement.

11: The lightweight cement composition of claim 1, wherein the FA has a specific gravity of about 2.56, and a water absorption of about 0.6% based on a total weight of the FA, as determined by ASTM C128.

12: A cured specimen made from the lightweight cement composition of claim 1, having a compressive strength of 3 to 30 MPa.

13: A cured specimen made from the lightweight cement composition of claim 1, having a thermal conductivity of 1 to 1.6 watts per meter-kelvin (W/mK).

14: A cured specimen made from the lightweight cement composition of claim 1, having a thermal resistivity of 0.8 to 1.5 m²K/W.

15: A method of making a cured lightweight cement specimen, comprising:
mixing the lightweight cement composition of claim 1 with water to form a mortar composition;
casting the mortar composition in a mold to form a molded composition; and
curing the molded composition for 0.5-30 days thereby forming the cured lightweight cement specimen.

16: The method of claim 15, wherein the water is at least one selected from the group consisting of tap water, ground water, distilled water, deionized water, fresh water, and desalted water.

17: The method of claim 15, wherein a weight ratio of water to the curable component present in the lightweight cement composition is in a range of 0.4:1 to 0.6:1.

18: The method of claim 15, further comprising preparing the SCP composite by:
placing particles of scoria in a chamber under a vacuum for an appropriate amount of time;
introducing PEG into the chamber in contact with the particles of scoria and heating in the vacuum environment to form a crude scoria composite; and
removing an excessive amount of PEG from the crude scoria composite by drying to form the SCP composite.

19: The method of claim 18, wherein the heating is performed at a temperature of 50 to 90° C. under a pressure of about 0.05 to 0.2 MPa.

20: The method of claim 15, further comprising constructing a building by:
aligning a plurality of cured lightweight cement specimens in side by side alignment to form a structural element of the building.
